(19) United States
(12) Patent Application Publication
(10) Pub. No.: US 2005/0191489 A1
(43) Pub. Date: Sep. 1, 2005

(54) Process for metallic coating of graphite discs or blocks and correspondingly metal-coated graphite discs or graphite blocks

(75) Inventor: Wilhelm Latz, Frankfurt/Main (DE)

Correspondence Address: Koda & Androlia;Suite 1140, 2029 Century Park East, Los Angeles, CA, 60067-2983, US

(73) Assignee: Deutsche Carbone AG

(21) Appl. No.: 10/918,526

(22) Filed: Aug. 13, 2004

(30) Foreign Application Priority Data
Aug. 15, 2003 (DE) 203 12 825.7 (U.M
Aug. 15, 2003 (DE) 103 38 148.1

(51) Int. Cl. C23C 4/00; B32B 5/16

(52) U.S. Cl. 428/403; 427/446

(57) ABSTRACT

Applying, onto graphite discs or blocks, especially carbon brushes of electric. machines, a metal coating which should have a high content of at least one metal, especially from the group comprising copper and tin, and which should reliably adhere to the graphite disc, so that the application is done in an environmentally friendly manner. To accomplish this, the metal is thermally sprayed onto a surface of the graphite disc or the graphite block.

### BACKGROUND OF THE INVENTION

1. Technical Field

The present invention relates to a process for applying a metal coating to graphite discs or blocks, especially carbon brushes of electric machines, according to the preamble of claim 1.

The present invention also relates to a correspondingly metal-coated graphite disc or graphite block, especially for a carbon brush of an electric machine. It is frequently desired to connect graphite discs or blocks with a metallic base body in such a way that electricity and heat ate readily conducted between them. According to the prior art, such connections or attachments are produced by soldering, as a rule. However, in order to anchor the solder in the graphite material the graphite surface requires extensive pretreatment.

2. Description of the Related Art

To improve this technique, it is already known to give the graphite disc or graphite block a metal coating, which can be soldered with the metallic base body in a simple and reliable manner.

To accomplish this, it is known to press together a so-called green compact from a material having a high graphite content containing a hardenable duroplastic or a thermoplastic as a binder, with a layer having a high metal content (DE 198 56 503 C1). As a rule, the green compact with its coating having a high metal content is put on the metallic base body, and is sintered together with the latter. This hardens the plastic component of the duroplastic in the molded piece, or bonds the thermoplastic, which solidly connects a solid, mechanically resistant molded piece with the metallic base body as a consequence of fusion, without conventional soldering.

To simplify manufacturing, an especially favorable variant of the preceding process is to mold and sinter the molded piece without a metallic body against/in the coating of material with a high metal content. According to this process, a thermoplastic can be used as a binder in the material with a high graphite content to bond it when sintering is used, or a duroplastic can harden in the material with a high graphite content, forming a mechanically resistant, dimensionally stable green compact without a metallic base body. This material with a high metal content contains essentially copper and/or zinc, which can be in the form of pure metals, but also in the form of alloys of these metals. Aside from zinc, it is also advantageous to use antimony, silver, and bismuth as alloying metals.

Although good results can be achieved according to this process, considerable time is required, when the layer of the material with a high metal content is put onto the layer of graphite particles, to avoid substantial metallic components or quantities of metal particles mixing with the layer of graphite particles, which can have a negative influence on the characteristics of the sintered compact.

It is also known to electroplate a graphite disc or a graphite block with copper or tin in order to make it solderable. However, here it is necessary to exclude the risk of the coating with the high metal content not sticking solidly to the graphite, for which reason the electroplating process requires a relatively large amount of effort. In addition, measures are necessary to make the process environmentally friendly, which, in particular, could include neutralization of baths to be released into the environment.

### BRIEF SUMMARY OF THE INVENTION

Therefore, the present invention is based on the task of creating a process for applying metal coatings to graphite discs or blocks which ensures good material separation of the graphite disc or graphite block and the coating having a high metal content (with the exception of a boundary layer between the graphite coating and the coating having a high metal content), while avoiding the disadvantages of known processes; the coating having a high metal content should reliably adhere to the graphite coating and should keep the burden on the environment very small when this production process is carried out.

This task is solved by a process according to claim 1.

A correspondingly metal-coated graphite disc or graphite block is characterized by the features of claim 8.

### DETAILED DESCRIPTION OF THE INVENTION

In the process according to the present invention, it is possible to use copper and tin or alloys of them for the coating having a high metal content. The metal coating that is thermally sprayed onto the graphite disc or graphite block adheres solidly to it, and thus it is possible to solder things to it without any problems.

In this respect, it has turned out to be especially advantageous to spray the metal onto the graphite disc or graphite block by plasma spraying.

Such plasma spraying is known especially in medical engineering for the production of prosthetic materials, in particular to spray titanium onto the prosthetic material, which generally includes ceramics (http://www.medicoat.ch/deutsch/plasmaspritzen.html).

Plasma spraying processes which are suitable for applying a metal coating to graphite discs or blocks are atmospheric plasma spraying and, in order to achieve especially dense metal coating without gaseous inclusions, vacuum plasma spraying.

In general, plasma spraying is carried out by igniting, between a pin-shaped cathode and a nozzle-shaped anode, an arc which heats, excites, dissociates, and ionizes plasma gas that is introduced in the hollow anode. A powdered spray material, in this case a metallic one, can be fed to the plasma jet outside of the anode, or also inside the anode; when this is done, the particles in the plasma jet are heated, melted, and accelerated onto the substrate in the form of the graphite disc or the graphite block, on which they settle to form a coating. When the coating is formed, a lamellar structure is produced that is characteristic of thermally sprayed coatings.

To improve the adhesion of the metal coating that is thermally sprayed onto the surface of the graphite disc or the graphite block, the surface can first be roughened by sandblasting with corundum, according to claim 7. The latter measure can also have advantageous effects for other thermal spraying processes which are alternatively used.

An alternative thermal spraying process which can be used to spray metal onto the graphite disc or graphite blocks is flame spraying, especially wire flame spraying. This involves using a flame or electrical heating to melt the metal to be spayed, and using compressed air or an inert gas to atomize it in order to sputter it onto the graphite disc or the graphite block to form a coating.

Another possible alternative is to produce the metal coating by melting the metal or the metals in an electric arc and atomizing it or them in a stream of gas which guides the particles to the surface to be coated.

The metal-coated graphite discs or coated graphite blocks advantageously produced according to the above claims, whose metal coating consists of a thermally sprayed layer, are specified in claims 8-15. The advantages of this coating consist in turn of the reliable, solid adhesion of the metal coating to the surface of the graphite disc or graphite block, which is preferably roughed up, the good material separation between the metal coating and the base material of the graphite disc or graphite block, and the favorable production process; it is also advantageous from the environmental perspective.

1. A process for applying to graphite discs or blocks, especially carbon brushes of electric machines, a metal coating with at least one metal, especially from the group comprising copper and tin, wherein the metal is thermally sprayed onto a surface of the graphite disc or block.

2. The process according to claim 1, wherein the metal is sprayed by plasma spraying.

3. The process according to claim 2, wherein the metal is sprayed by vacuum-plasma spraying.

4. The process according to claim 1, wherein the metal is sprayed by flame spraying.

5. The process according to claim 4, wherein the metal is sprayed by wire flame spraying.

6. The process according to claim 1, wherein the metal is sprayed by electric-arc spraying.

7. The process according to any one of claims 1 through 7, wherein the surface of the graphite discs or graphite blocks is roughened by sandblasting with corundum before the metal coating is sprayed on.

8. A metal-coated graphite disc or graphite block, especially for a carbon brush of electric machines, whose metal coating is comprised essentially of copper and/or tin, wherein coating is applied by thermal spraying.

9. The metal-coated graphite disc or graphite block according to claim 8, wherein coating is applied by plasma spraying.

10. The metal-coated graphite disc or graphite block according to claim 9, wherein coating is applied by vacuum plasma spraying.

11. The metal-coated graphite disc or graphite block according to claim 8, wherein coating is applied by flame spraying.

12. The metal-coated graphite disc or graphite block according to claim 11, wherein coating is applied by wire flame spraying

13. The metal-coated graphite disc or graphite block according to claim 8, wherein coating is applied by electric-arc spraying.

14. The metal-coated graphite disc or graphite block according to any one of claims 8 through 13, wherein the metal coating is sprayed onto a roughed-up surface of the graphite disc or graphite block.

15. The metal-coated graphite disc or graphite block according to any one of claims 8 through 14, wherein the metal coating has a lamellar structure.
